(19) United States
(12) Patent Application Publication
(10) Pub. No.: US 2020/0265442 A1
(43) Pub. Date: Aug. 20, 2020

(54) SYSTEM AND METHOD FOR A VEHICLE CUSTOMER SUPPORT BLOCKCHAIN-BASED PLATFORM

(71) Applicant: TOYOTA MOTOR ENGINEERING & MANUFACTURING NORTH AMERICA, INC., Plano, TX (US)

(72) Inventor: Nutonya L. PARKER, Dallas, TX (US)

(73) Assignee: TOYOTA MOTOR ENGINEERING & MANUFACTURING NORTH AMERICA, INC., Plano, TX (US)

(21) Appl. No.: 16/277,514

(22) Filed: Feb. 15, 2019

(51) Int. Cl. G06Q 30/00; H04L 29/06; H04L 9/32; G06Q 20/40; G06Q 20/38

(52) U.S. Cl. CPC G06Q 30/016; H04L 63/123; H04L 9/3234; H04L 2209/84; G06Q 20/389; H04L 2209/38; H04L 2209/56; G06Q 20/40

(57) ABSTRACT

A system, a method, and non-transitory computer readable medium for providing a vehicle customer service platform. The method includes storing vehicle information on a blockchain ledger, providing a user entity access to a vehicle customer service platform, and updating the blockchain ledger based on input from the user entity.

### BACKGROUND

Various transactions relating to a vehicle may be stored over the life of a vehicle. Further, a vehicle owner may interact with one or more entities to conduct transactions related to the vehicle. U.S. Patent Publication No. 2018/0018723 entitled “Distributed ledger platform for vehicle records” by Nagla describes a vehicle record platform using blockchain technology.

The foregoing “Background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention.

### SUMMARY

The present disclosure relates to a method that stores vehicle information on a blockchain ledger, provides a user entity access to a vehicle customer service platform, and updates the blockchain ledger based on input from the user entity.

The present disclosure also relates to a system for providing a vehicle customer service platform. The system includes a blockchain ledger for storing vehicle information, communication circuitry, and a blockchain processor. The communication circuitry is configure to communicate with updating entities including a user entity. The blockchain processor is configured to provide a vehicle customer service platform to the user entity, and update the blockchain ledger based on input from the user entity.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic that shows a system environment of a blockchain-based system according to one example;

FIG. 2 is a block diagram of a blockchain-based platform according to one example;

FIG. 3 is a flowchart for a method for blockchain-based customer support according to one example; and

FIG. 4 is a block diagram of a computer according to one example.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a program module, a script, a function, a procedure, an object method, an object implementation, in an executable application, an applet, a servlet, a source code, an object code, a shared library/dynamic load library and/or other sequence of instructions designed for execution on a computer system.

Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Referring now to the drawings, wherein like reference numerals designate identical or corresponding parts throughout several views, the following description relates to a system and associated methodology for providing a blockchain-based vehicle customer service platform.

Conventional vehicle customer-service systems involve call centers and computerized records of interactions with customers (e.g., “tickets” for complaints/trouble). Resolving a consumer's complaint often involves communications among different departments within the enterprise that manufactured the vehicle. These different parts of the enterprise do not always communicate well with one another, making it more difficult to provide the assistance to the consumer needs. Often, this difficulty stems from the lack of a smooth, efficient system for reliably sharing needed, verified data. In addition, if a customer has a disability (e.g., is hearing-impaired) or struggles with language, these challenges are compounded. Conventional chat-based platforms are not able to authenticate a customer and validate ownership without using audio communications.

The system described herein improves flow of information within one or more entities, to provide a secure blockchain-based platform for customer support. As described further below, agents may make adjustments remotely without compromising security.

The system described herein tracks a vehicle and component parts of the vehicle from the manufacturing stage through the entire life of the vehicle (i.e., until it is no longer usable). The system provides a platform or “ecosystem” for enhanced customer support. Each transaction and associated information are stored in a blockchain. A transaction refers to an event or the like that changes a vehicle's state.

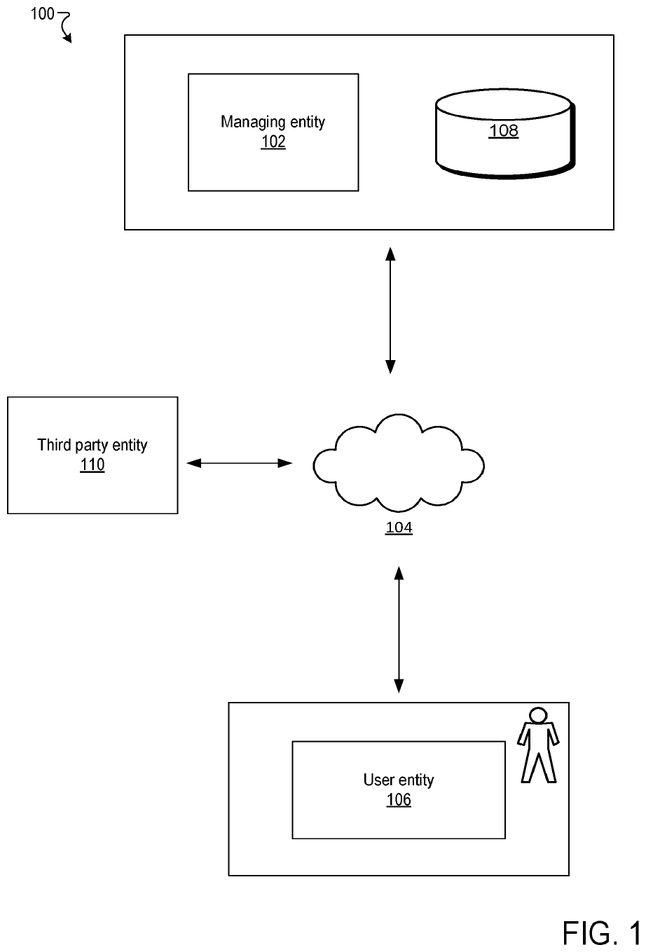

FIG. 1 is a schematic that shows a system environment of a blockchain-based system 100, herein referred to as system 100, according to one example. The system 100 includes a managing entity 102, a network 104, a user entity 106, a database 108, and a third party entity 110. As used herein, blockchain refers to a distributed storage platform and network in which individual blocks are connected in a chain. Each block is linked to the previous block in the blockchain by, for example, including a hash of the previous block.

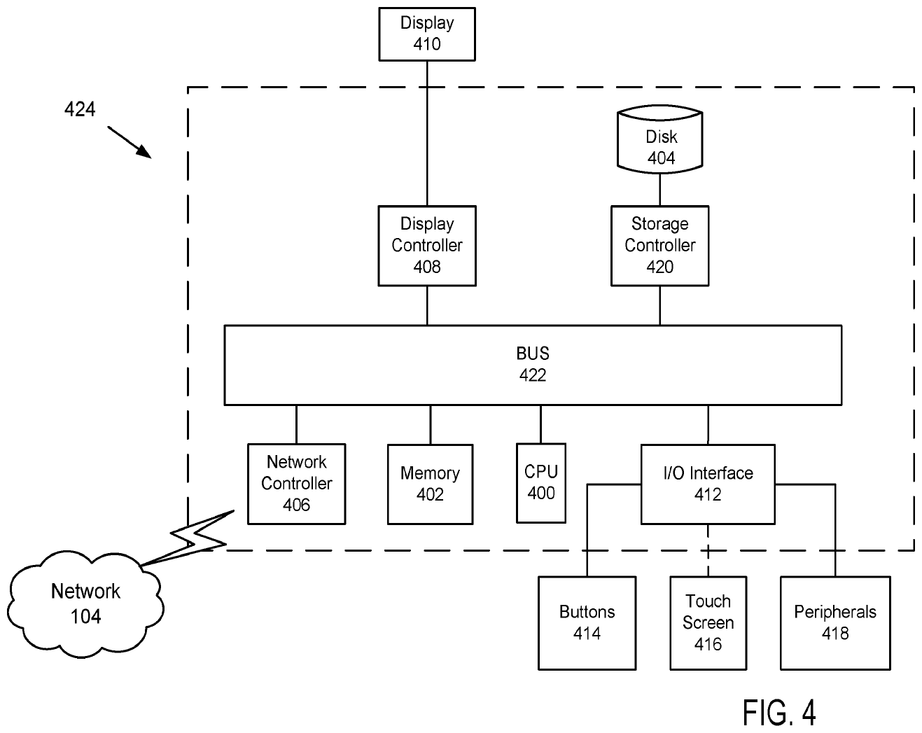

The managing entity 102 can represent one or more managing entities connected to the user entity 106. The managing entity 102 can include processing circuitry to perform various processing for the system 100 including receiving customer service requests from one or more of the user entities 106 via the network 104. The managing entity 102 may be a server that includes a CPU 400 and a memory 402 as shown in FIG. 4. The server 102 may also include one or more communications interfaces for communicating with the user entity 106. The server 102 may be located remotely from other servers components (e.g., database 108), such as in a distributed system.

The network 104 can represent one or more networks connecting the managing entity 102 and the user entity 106. The network 104 is any network that allows the managing entity 102 and the user entity 106 to communicate information with each other. Suitable networks can include or interface with any one or more of a local intranet, a PAN (Personal Area Network), a LAN (Local Area Network), a WAN (Wide Area Network), a MAN (Metropolitan Area Network), a VPN (Virtual Private Network), or a SAN (storage area network). Furthermore, communications may also include links to any of a variety of wireless networks, including WAP (Wireless Application Protocol), GPRS (General Packet Radio Service), GSM (Global system for Mobile Communication), CDMA (Code Division Multiple Access) or TDMA (Time Division Multiple Access), cellular phone networks, GPS (Global Positioning System), CDPD (Cellular digit packet data), Bluetooth radio, or an IEEE 802.11 based radio frequency.

In one implementation, the network 104 may be a vehicle to infrastructure interaction (V2I). The network 104 is used to communicate with third party entities 110 such as an insurance company.

The user entity 106 can represent one or more user entities. The user entity 106 may refer to one or more computers, computing entities, desktop computers, mobile phones, tablets, notebooks, laptops, distributed systems, watches, and the like.

The database 108 can represent one or more databases. The database 108 may store one or more blocks of the blockchain. A blockchain may be stored across multiple databases 108 for enhanced security. Information stored on ledgers may include information regarding repairs, servicing, financial services history, telematics subscription, and the like. The entity may use the information for verification. For example, a call center associated with a vehicle manufacturer or the managing entity may use the data to support the resolution of a customer complaint.

In one implementation, the one or more databases of blockchain data may contain data residing in one or more public blockchains, one or more private blockchains, or some combination thereof. In one implementation, each block includes a vehicle identification number (VIN) along with corresponding vehicle and transaction data. Further, each individual block of the blockchain may or may not be related (e.g., may or may not be associated with a same vehicle).

The third party entity 110 can represent one or more third party entities. The managing entity 102 (e.g., vehicle manufacturer) may provide one or more blockchains across the one or more third party entities. Third party entities may represent any possible participant that may engage in a transaction that either changes, or validates the state of an item in a distributed ledger or blockchain. The third party entities may include telematics, finance, insurance, warranty, repair/service, and customer-care.

Each agent or entity may be assigned different trust attributes. Further, each agent may have different authorization to the distributed ledger (e.g., append and/or read authorization). A transaction may include a service request, an account change, a purchase/sale, a loan, a subscription, an invoice payment, or the like.

The entities may verify data, update data, and/or input additional transactions. In one implementation, the blockchain is accessible by one entity (e.g., vehicle manufacturer). Data is available to various department of the entity.

The blockchain is associated with the vehicle throughout the vehicle's lifecycle. For example, the blockchain may be transferred to another owner. Authorization to access blocks may be based on the entity. For example, a new owner has authorization to access blocks associated with the vehicle record but may not access financial information included in the blockchain associated with the previous owner.

Entities may use the stored data to validate past transactions. For example, the owner and the automaker may retrieve data from the blockchain to investigate something in the past (e.g., build quality, manufacturing anomalies, replacement of a part after retail sale, and services performed during a particular service visit after retail sale).

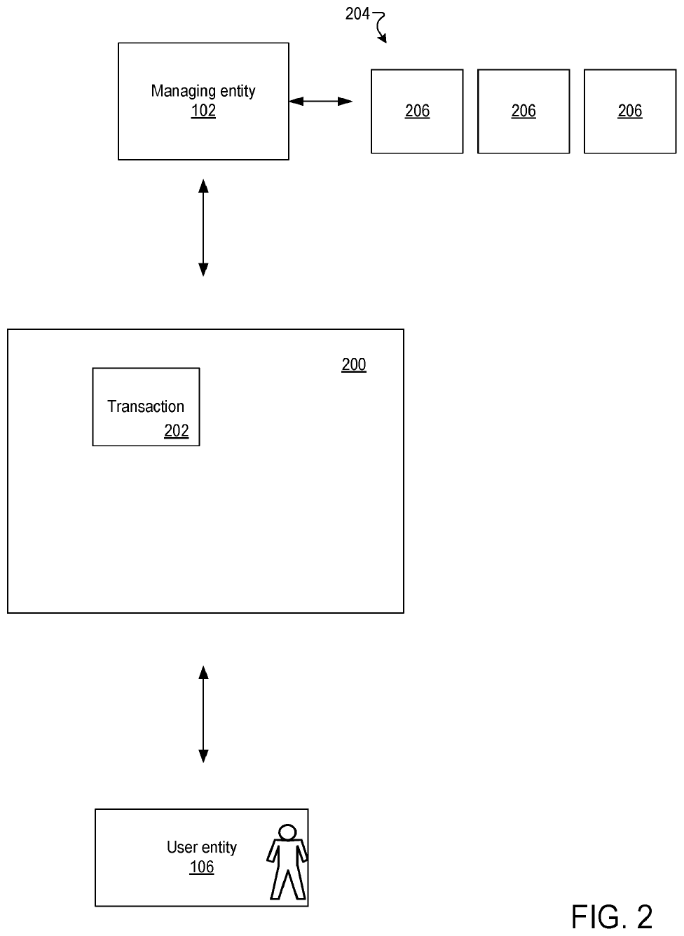

The system 100 may include a text-based platform 200 for online customer service, referred to herein as platform 200, as shown in FIG. 2. The managing entity 102 or the user entity 106 may initiate a transaction 202. The managing entity 102 updates blockchain 204 that includes multiple blocks 206. The platform 200 may be beneficial for customers with hearing difficulties. In addition, the platform 200 provides the advantage of not sharing verbally private information when an individual is located in a public area. A call-center agent associated with the managing entity 102 or the third party entity 110 and the user entity 106 may access the platform 200. The user entity 106 may be identified using the blockchain system 100 without the need of audibly identifying the user. The user provides authorization to transact business with the managing entity 102. In one example, the platform 200 may be used to request changes in telematics subscription.

An agent of the managing entity 102 may fulfill the request without concerns about payment card industry (PCI) compliance concerns. In addition, personally identifiable information (PII) about the user remains safe because there is no need to capture payment or personal information outside of the agent's customer relationship management system. Once a ledger is distributed to the nodes across the system 100 all the transaction attributes (e.g., part, owner, price, sell date, purchase date, and the like) are registered to all of the other copies of the ledgers within the blockchain at the same time. The transactions can only be viewed as read only by anyone. The enterprise or managing entity 102 can also establish a consensus mechanism for accessing account and payment histories. The enterprise or the managing entity 102 uses a combination of permissioned blockchain ensuring every node can be identified by the enterprise and proof of work proving the qualifications to accept and initiate transactions on the ledger coupled with proof stake to validate asset holdings (primarily in terms of availability) without disclosing the personal identity of the customer unless needed to complete the transaction.

The system described herein provides for safer, more secure transactions while reducing human errors. The agent and the user are confident that the person initiating a transaction and then executing the request are both authorized to conduct business with each other. For example, each transaction is signed with a private key. The system validates that the private key signature corresponds to the public key initiating the transaction and that funds or assets (e.g., vehicle or part for sale) are available (based on existing blocks) for trade.

Users have complete control of accounts associated with the vehicle without the need for input from others. Therefore, users are confident that the information associated with each account is secure because the user initiates (i.e., service request, account changes, or the like) or approves (i.e., purchase/sale, loan, subscription, invoice payments, or the like) all actions. Each entity is accountable and liable for actions without influence from another entity.

Data in the blockchain aid in fulfilling all auditing needs. Neither the consumer nor the enterprise (e.g., the managing entity 102, the user entity 106) has to rely on the other to validate or endorse the other. The system 100 manages acceptance or rejection of transaction attempts based on the historical data found in the ledger. The system 100 performs checks across the blockchain and ledger to ledger. Auditors may validate all of the entity's transactions. Auditors may use proprietary APIs to extract the data for extensive reviews when necessary.

Transaction 202 may include input data that references one or more transactions. For example, a transaction may reference vehicle record, previous chat via the platform 200, or the like.

Each entity has access only to information, transactions, and opportunities for interaction that are relevant to each entity.

Each block 206 may include multiple portions. Each portion may be a private portion or a public portion. An identifier stored into the database 108 may identify the portion as private or public. The private portion may include financial information associated with the transaction 202. The public portion may include services subscriptions and may be accessed by third parties entities 110.

Transactions 202 and information exchanged via the platform 200 may include customer information, approved drivers/users information, vehicle information, purchase transaction information, financing information, insurance information, service transaction, repairs information, subscription transactions, support interactions, municipality registration, inspection, law enforcement data, and the like.

For example, the user entity 106 may connect via the platform 200 to update a subscription. The managing entity 102 may have access to the financial information stored on the ledger. Further, the user entity 106 may connect via the platform 200 to resolve technical problems of the vehicle. The managing entity 102 may share the ledger with a third entity (e.g., mechanic) to help with the diagnostic and the resolution of the complaint.

In one implementation, the information may further include diagnostics (e.g., battery, tire, and the like), driver behavior, sensor data, vehicle location, safety services, navigation information, over the air (OTA) updates to software/firmware, car sharing, and the like. For example, the managing entity 102 may initiate an OTA update to one or more software of the vehicle. The user entity 106 automatically authenticates the managing entity 102 to authorize the update.

In one implementation, the information also includes operating system, system failures or anomalies, performance data, control, connectivity, device diagnostics, network performance data, and the like when the vehicle is an autonomous vehicle.

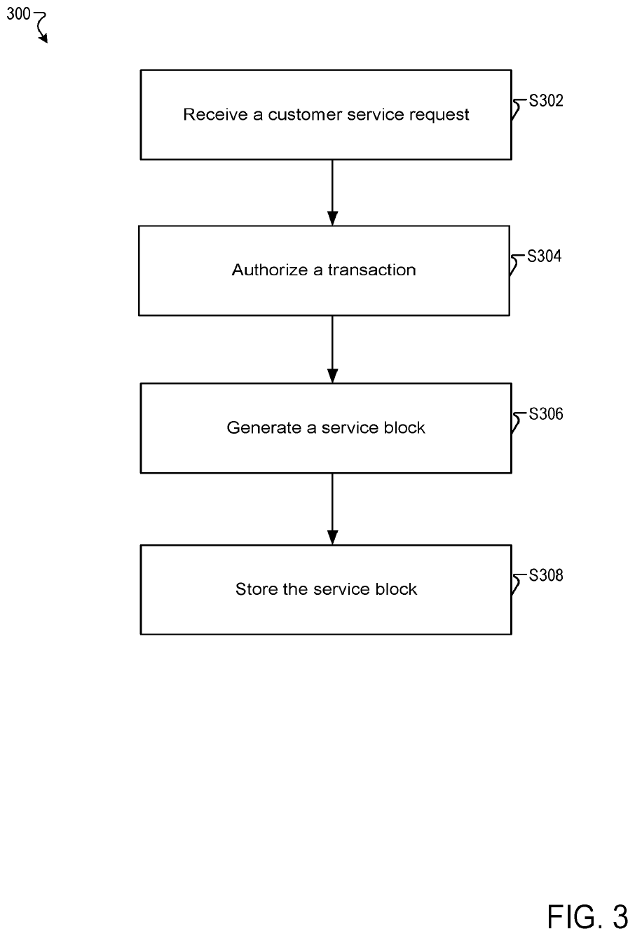

FIG. 3 is a flowchart 300 of a method for blockchain-based customer support according to one example. At step 302, the managing entity 102 may receive a request from the user entity 102. The request may be a customer service request received via the platform 200. The managing entity 102 can be configured to perform a verification of the user identity that may access information stored in the blockchain. In one example, identity information for a user may be encrypted and the encrypted identity information stored in the blockchain.

In one implementation, the managing entity 102 may receive a request from a customer to connect to the platform 200. The managing entity 102 may request identification from the user entity 106 in the form of a blockchain token. The managing entity 102 may authenticate the user entity 106 using the blockchain token as the identification.

At step 304, the managing entity 102 may authorize a transaction. The managing entity 102 may manage the transaction based on a type of profile of a customer. In one implementation, users may be categorized into potential customers, new customers, and established customers. The managing entity 102 may determine the category or type of the customer.

Potential customers are customers interested in following up on marketing campaigns, inquiries, surveys, contests, and the like. Potential customers have access to transactions related to campaigns, inquiries, surveys, and the like. A private key is associated with the user (potential customer) but with no asset associations. In one implementation, the system 100 may create an establish information ledger (creation of non financial transaction ledger allowing for information exchange only), send a request to the managing entity 102. The managing entity 102 may verify the request based on a gain agreement (e.g., a private key and public key). Once the data is verified, the block is added to the blockchain.

New Customers establish or transition the potential ledger by either the creation of a transaction ledger or requesting a transaction to convert the information ledger to a transaction ledger. The system establishes a transaction ledger then follows the established protocols as described below.

Established customers follow the customary protocol for all transactions (information and financial). For example, the following protocol may be used: a request is received, an agreement (Private Key 1 and Public Key 1) is created, a validation by (Private 2 and Public Key 2) is performed, then a private key signature authorizing initiating transaction, a verification and a private key authorizing accepting transaction, then a block are added).

At step 306, the managing entity 102 may generate a service block that includes data exchanged during the chat. In other words, the managing entity 102 may apply a new current state to the transaction. Further, the service block includes any transactions with third party entity.

The managing entity 102 may send an acknowledgment to the user entity 106 that the transaction is authorized and the service block generated. The user entity 106 may also acknowledge the transaction.

At step 308, records of the transactions are stored in the blockchain, for example, in the database 108. In one example, the service block is stored in the blockchain.

In one implementation, each interaction between a user and the managing entity is confirmed at the end of the interaction. The final confirmation indicates that the transaction is successful. The transaction is recorded in the ledger. Therefore, all future participants and third party entities can trust the transaction as would be understood by one of ordinary skill in the art.

Each participant entity has the history of each transaction or relevant information. Therefore, a current status is distributed across the appropriate network.

In one implementation, a first user (e.g., customer service agent) is authenticated to a block. A private and a public key Agreement may be used.

The first user may write data (e.g., subscription details, authorization to subscribe to one or more subscription) to blockchain. Then, the data is validated by a second user (e.g., vehicle owner). The second user may also replicate the data. The second user or other entities may read the data from the blockchain later for use in implementing one or more services. For example, the third entities may read the data to implement a new service that the customer subscribed via the chat-based platform. Each of the connected car participants transact on the blockchain. For example, the customer may subscribe, the agent validates the request, finance and accounting validates funds and capture the record, the telematics service provider (TSP) may receive a transaction request to permit the service, the vehicle receives a request to accept the permission and turn on the services. The respective ledgers have a record of the transaction from subscription interest to subscription to payment to execution.

In one implementation, the functions and processes of the managing entity 102 may be implemented by a computer 424. Next, a hardware description of the computer 424 according to exemplary embodiments is described with reference to FIG. 4. In FIG. 4, the computer 424 includes a CPU 400 which performs the processes described herein. The process data and instructions may be stored in memory 402. These processes and instructions may also be stored on a storage medium disk 404 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computer 426 communicates, such as a server or computer.

Further, the claimed advancements may be provided as a utility application, background daemon, or component of an operating system, or combination thereof, executing in conjunction with CPU 400 and an operating system such as Microsoft® Windows®, UNIX®, Oracle® Solaris, LINUX®, Apple macOS® and other systems known to those skilled in the art.

In order to achieve the computer 426, the hardware elements may be realized by various circuitry elements, known to those skilled in the art. For example, CPU 400 may be a Xenon® or Core® processor from Intel Corporation of America or an Opteron® processor from AMD of America, or may be other processor types that would be recognized by one of ordinary skill in the art. Alternatively, the CPU 400 may be implemented on an FPGA, ASIC, PLD or using discrete logic circuits, as one of ordinary skill in the art would recognize. Further, CPU 400 may be implemented as multiple processors cooperatively working in parallel to perform the instructions of the inventive processes described above.

The computer 426 in FIG. 4 also includes a network controller 406, such as an Intel Ethernet PRO network interface card from Intel Corporation of America, for interfacing with network 104. As can be appreciated, the network 104 can be a public network, such as the Internet, or a private network such as LAN or WAN network, or any combination thereof and can also include PSTN or ISDN sub-networks. The network 104 can also be wired, such as an Ethernet network, or can be wireless such as a cellular network including EDGE, 3G and 4G wireless cellular systems. The wireless network can also be WiFi®, Bluetooth®, or any other wireless form of communication that is known.

The computer 424 further includes a display controller 408, such as a NVIDIA® GeForce® GTX or Quadro® graphics adaptor from NVIDIA Corporation of America for interfacing with display 410, such as a Hewlett Packard® HPL2445w LCD monitor. A general purpose I/O interface 412 interfaces with a keyboard and/or mouse 414 as well as an optional touch screen panel 416 on or separate from display 410. General purpose I/O interface also connects to a variety of peripherals 418 including printers and scanners, such as an OfficeJet® or DeskJet® from Hewlett Packard®.

The general purpose storage controller 420 connects the storage medium disk 404 with communication bus 422, which may be an ISA, EISA, VESA, PCI, or similar, for interconnecting all of the components of the computer 424. A description of the general features and functionality of the display 410, keyboard and/or mouse 414, as well as the display controller 408, storage controller 420, network controller 406, and general purpose I/O interface 412 is omitted herein for brevity as these features are known.

The features of the present disclosure provide a multitude of improvements in the technical field of customer service management. Other authentication and validation processes require both the consumer and purveyor to store the same credentials. This information is vulnerable to hacking or other forms of attack. Data validation must also take into account changes, require awareness of expiration periods, or may require multiple methods/factors to gain access.

A blockchain-based consumer support system alleviates the need for access control list (ACL). An ACL is a list of authorized users. The ACL must remain accurate. The system described herein minimizes the need to update or maintain the ACL list thus minimizing computation and storing requirement. The blockchain ledgers alleviate the need to store authorized user credentials in a database.

Further, the blockchain-based system described herein alleviates the need for a dialed number identification service (DNIS). The DNIS reveals the number dialed and authorizes a dial-in connection based on the number called thus providing an indication of the purpose of the call based on this number. Using the system described herein, the initiation of the transaction via the blockchain as described previously herein indicates a reason for the reason of the interaction. Therefore, the system described herein minimizes resource requirement. Many companies establish numerous Toll Free Numbers (TFN) for inclusion on marketing communications and bills. Use of the TFN tells the company why the customer is calling. Simply initiating a request alleviates the need for specialized entry points for customer service support.

The user name and password are not necessarily sent over the network, therefore improving the security of the data. Further, there is no need for network access authentication, therefore improving the security of the data.

Conventional systems include public key certificates issued by a trusted certificate authority (CA) or a simple pre-shared secret key (a string of characters known to both the sender and the recipient). Both the user and recipient systems must be configured to use a shared and common authentication method. The system described alleviates the need for a shared authentication method. Instead of issuing certificates (that must be stored, shared with the customer, and protected) to validate the customer. The ledgers confirm if a customer is eligible to request and fulfill a transaction.

Thus, the system described herein provides a technical solution for the ever growing requirements in terms of the sheer number of services, applications, and systems requiring some type of authentication coupled with the management of all the credentials.

The system described herein provides a universal solution to consumer validation and authentication lending itself to providing an optimal experience regardless of preferences or needs. Each consumer deserves the ability to transact business in the manner that makes them most comfortable but that is also safe and secure and that conform to enterprise and/or regulatory requirement. The system described herein does not diminish nor negate the use of traditional transactional methods but enhance the security needed as technological influences increase.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A system for providing a vehicle customer service platform, comprising:
a blockchain ledger for storing vehicle information;
communication circuitry configured to communicate with updating entities including a user entity; and
a blockchain processor configured to
provide a user entity access to a vehicle customer service platform, and
update the blockchain ledger based on input from the user entity.

2. The system of claim 1, wherein the processing circuitry is further configured to:
receive a customer service request from the user entity;
verify the customer service request;
and
generate a service block based on data exchanged with the user entity.

3. The system of claim 2, wherein the service block includes modification attributes to one or more services.

4. The system of claim 2, wherein the service block includes include a private portion and a public portion.

5. The system of claim 4, wherein the private portion includes financial information.

6. The system of claim 4, wherein the public portion includes subscription information.

7. The system of claim 2, wherein the processing circuitry is further configured to:
authorize a transaction.

8. The system of claim 7, wherein the transaction includes a service request, an account change, or an invoice payment.

9. The system of claim 1, wherein the blockchain ledger is stored across multiple databases.

10. The system of claim 1, wherein the processing circuitry is further configured to:
receive a request from the user entity to connect to the vehicle customer service platform;
request from the user entity identification in the form of a blockchain token; and
authenticate the request using the blockchain token as identification.

11. The system of claim 1, wherein the communication circuitry is configured to communicate with the updating entities via a vehicle to infrastructure access point.

12. A method for providing a vehicle customer service platform, comprising:
storing vehicle information on a blockchain ledger;
providing, using communication circuitry, a user entity access to a vehicle customer service platform; and
updating, using processing circuitry, the blockchain ledger based on input from the user entity.

13. The method of claim 12, further comprising:
receiving a customer service request from the at least user entity;
verifying the customer service request; and
generating a service block based on data exchanged with the at least user entity.

14. The method of claim 13, wherein the service block includes modification attributes to one or more services.

15. The method of claim 13, wherein the service block includes include a private portion and a public portion.

16. The method of claim 15, wherein the private portion includes financial information.

17. The method of claim 15, wherein the public portion includes subscription information.

18. The method of claim 12, further comprising:
receiving a request from the user entity to connect to the vehicle customer service platform;
requesting from the user entity identification in the form of a blockchain token; and
authenticating the request using the blockchain token as identification.

19. The method of claim 12, wherein the communication circuitry is configured to communicate with updating entities via a vehicle to infrastructure access point.

20. A non-transitory computer readable medium storing computer-readable instructions therein which when executed by a computer cause the computer to perform a method for providing a vehicle customer service platform, the method comprising:
storing vehicle information on a blockchain ledger;
providing a user entity access to a vehicle customer service platform; and
updating the blockchain ledger based on input from the user entity.
